(19) United States
(12) Patent Application Publication
(10) Pub. No.: US 2018/0068324 A1
(43) Pub. Date: Mar. 8, 2018

(54) OUTPUTTING CONTENT BASED ON INTERESTS OF OTHER USERS

(71) Applicant: Google Inc., Mountain View, CA (US)

(72) Inventors: Lori Meiskey, Mountain View, CA (US); Joseph Linn, Mountain View, CA (US)

(21) Appl. No.: 15/257,878

(22) Filed: Sep. 6, 2016

(51) Int. Cl. G06Q 30/02; H04L 29/08

(52) U.S. Cl. CPC G06Q 30/0201; H04L 67/22; H04L 67/306

(57) ABSTRACT

A computing system is described that determines, based on survey information, a group of users of computing devices who have expressed interest in an event, wherein the group of users is included in a plurality of users, and wherein each of the plurality of users has an interest profile. The computing system also determines, based on the interest profiles for each of the users in the group of users, one or more interests indicating interest in the event, and identifies, based on the one or more interests indicating interest in the event, a user not included in the group of users that has an interest profile including the one or more interests indicating interest in the event. The computing system also transmits, to a computing device associated with the user, information about the event.

### BACKGROUND

Some computing systems that provide information to users of computing devices may attempt to only provide information to the computing devices of users who the computing system determines are likely to be interested in seeing, hearing, or otherwise consuming the information. However, for certain types of information, determining which users or groups of users are likely to be interested in a particular item of information may be difficult for some computing systems, thereby causing some computing systems to send information to the computing devices of users who have little or no interest in the information. Sending unwanted information to computing devices of users who are not interested in consuming the information may waste computing resources and annoy or distract the users.

### SUMMARY

In one example, a method comprises determining, by a computing system, based on survey information, a group of users of computing devices who have expressed interest in an event, wherein the group of users is included in a plurality of users, and wherein each of the plurality of users has an interest profile. The method also includes determining, by the computing system, based on the interest profiles for each of the users in the group of users, one or more interests indicating interest in the event, identifying, by the computing system, based on the one or more interests indicating interest in the event, a user not included in the group of users that has an interest profile including the one or more interests indicating interest in the event, and transmitting, by the computing system, to a computing device associated with the user, information about the event.

In another example, a computing system comprises: at least one processor; and at least one storage device. The storage device stores instructions that, when executed, cause the at least one processor to: determine, by a computing system, based on survey information, a group of users of computing devices who have expressed interest in an event, wherein the group of users is included in a plurality of users, and wherein each of the plurality of users has an interest profile; determine, by the computing system, based on the interest profiles for each of the users in the group of users, one or more interests indicating interest in the event; identify, by the computing system, based on the one or more interests indicating interest in the event, a user not included in the group of users that has an interest profile including the one or more interests indicating interest in the event; and transmitting, by the computing system, to a computing device associated with the user, information about the event.

In another example, a computer-readable storage medium comprises instructions that, when executed, cause at least one processor of a computing system to: determine, by a computing system, based on survey information, a group of users of computing devices who have expressed interest in an event, wherein the group of users is included in a plurality of users, and wherein each of the plurality of users has an interest profile, determine, by the computing system, based on the interest profiles for each of the users in the group of users, one or more interests indicating interest in the event, and identify, by the computing system, based on the one or more interests indicating interest in the event, a user not included in the group of users that has an interest profile including the one or more interests indicating interest in the event. The instructions, when executed, further cause the at least one processor of the computing system to transmit to a computing device associated with the user, information about the event.

### BRIEF DESCRIPTION OF THE DRAWINGS

FIG. 1 is a conceptual diagram illustrating an example system for identifying users that may be interested in an upcoming event, in accordance with one or more aspects of the present disclosure.

FIG. 2 is a block diagram illustrating an example computing system that is configured to identify users that may interested in an upcoming event, in accordance with one or more aspects of the present disclosure.

FIG. 3 is a block diagram illustrating an example computing device that is configured to operate in accordance with one or more aspects of the present disclosure.

FIG. 4 is a conceptual diagram illustrating an example computing system that is configured to identify users that may be interested in an upcoming event, in accordance with one or more aspects of the present disclosure.

FIG. 5 is a conceptual diagram illustrating a simplified example concept map illustrating relationships between a number of concepts or topics.

FIG. 6 is a flow diagram illustrating operations performed by an example computing system in accordance with one or more aspects of the present disclosure.

### DETAILED DESCRIPTION

This disclosure is directed to techniques that include enabling a computing system to identify users of computing devices that may be interested in information based on expressed interests from other users of computing devices that expressed an interest in topics related to the information. In some examples, and in accordance with one or more aspects of the present disclosure, an example computing system may identify users that may be interested in information about a topic, such as an upcoming event, and may output an indication of the information about the upcoming event to one or more computing devices associated with the identified users.

For instance, an example computing system may maintain, for each user from a group of users, an interest profile. The interest profile may include an indication of one or more interests derived or inferred from individual user activity or contextual information associated with the individual users, such as browsing history, searches performed, purchase histories, communication information, and other information indicating user activity or contextual information associated with the individual users. The example computing system may also obtain information associated with an electronic survey taken by a subset of the users from the group from which the computing system may identify one or more users that have expressed interest in an upcoming event. The computing system may determine which interests in the interest profiles of the group of users suggest or are correlated with surveyed users' expressed interest in the upcoming event. The computing system may use the determined interests to identify other users, including those not included in the subset of the users who took the electronic survey, having one or more of the same interests in their interest profiles and thereby infer that the other users are also likely to have an interest in the upcoming event. The computing system may send information (e.g., as a graphical, haptic, or audible notification) to one or more computing devices associated with those identified users.

The computing system may be able to effectively identify users interested in an upcoming event, and as a result, the computing system may be able to avoid sending information about an upcoming event to too many users, particularly, those users who are not interested in the event. Therefore, the computing system may avoid distracting and wasting the time of users that are not likely interested in the information. Also, by not sending information to users who are not likely interested in the information, the computing system may perform less computing and network operations. Further, by effectively identifying users interested in an upcoming event, the computing system may be more likely to identify, rather than fail to identify, users who are interested in receiving information about the upcoming event. Accordingly, computing system may be more likely to provide information to users that need, desire, appreciate, or may otherwise benefit from the information.

Throughout the disclosure, examples are described where a computing device and/or a computing system analyzes information (e.g., interest profiles, survey responses, context, locations, speeds, search queries, etc.) associated with a computing device and a user of a computing device, only if the computing device receives permission from the user of the computing device to analyze the information. For example, in situations described or discussed in this disclosure, before a computing system or one or more computing devices operated by users collect or make use of information associated with a user, the user may be provided with an opportunity to provide input to control whether programs or features of the computing system and/or one or more computing devices operated by users can collect and make use of user information (e.g., interest profiles, search information, survey information, information about a user's current location, current speed, etc.), or to dictate whether and/or how to the device and/or system may receive content that may be relevant to the user. In addition, certain data may be treated in one or more ways before it is stored or used by a computing system and/or computing devices operated by users, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by a computing system and/or computing devices operated by the user.

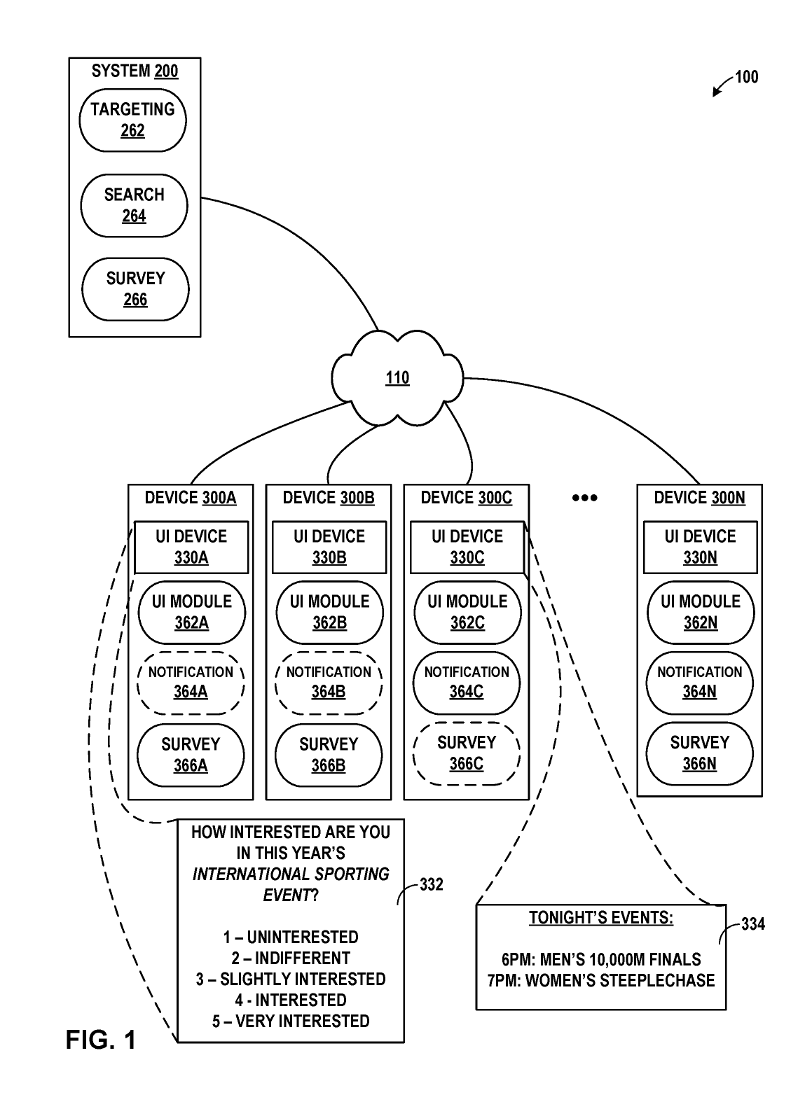

FIG. 1 is a conceptual diagram illustrating an example system for identifying users that may be interested in an upcoming event, in accordance with one or more aspects of the present disclosure. In FIG. 1, computing system 200 of system 100 may identify users interested in the upcoming event, and computing system 200 may also deliver content to one or more computing devices 300A-300N (collectively referred to as “computing devices 300”). FIG. 1 illustrates only one particular example of system 100, and other examples of system 100 may be implemented or used in other instances and may include a subset of the components included in example system 100 or may include additional components not shown in FIG. 1.

Network 110 may be the internet, or may represent any public or private communications network, for instance, cellular, Wi-Fi, and/or other types of networks, for transmitting data between computing systems, servers, and computing devices. Network 110 may include one or more network hubs, network switches, network routers, or any other network equipment, that are operatively inter-coupled thereby providing for the exchange of information between computing system 200 and computing devices 300. Computing system 200 and computing devices 300 may transmit and receive data across network 110 using any suitable communication techniques. Computing system 200 and computing devices 300 may each be operatively coupled to network 110 using one or more network links. The links coupling computing devices 300 and computing system 200 to network 110 may be Ethernet, ATM or other types of network connections, and such connections may be wireless and/or wired connections.

Computing devices 300 may each represent an individual mobile or non-mobile device, such as a mobile phone, a tablet computer, a laptop or desktop computer, computerized watch, computerized eyewear, computerized glove or gloves, or any other type of mobile or non-mobile computing device. Additional examples of computing devices 300 include personal digital assistants (PDAs), gaming systems, media players, e-book readers, television platforms, automobile navigation and entertainment (e.g., infotainment) systems, or any other type of mobile or non-mobile, wearable and non-wearable computing devices configured to receive information via a network, such as network 110.

Each of computing devices 300 may include a respective user interface device 330A-330N (collectively “user interface devices 330”) and a respective user interface module 362A-362N (collectively “user interface modules 362”). In addition, one or more of computing devices 300 may include a respective notification module 364A-364N (collectively “notification modules 364”) and/or a respective survey module 366A-366N (collectively “survey modules 366”). For example, as shown in FIG. 1 computing devices 300A and 300B may include survey modules 366A and 366B, respectively, but may not necessarily include notification modules 364A and 364B which are shown using dashed outlines as being optional components of computing devices 300A and 300B. Likewise, as shown in FIG. 1, computing devices 300C may include notification module 364C but may not necessarily include survey module 366C which is shown using dashed outlines as being an optional component of computing device 300C. Finally, as shown in FIG. 1, computing devices 300N may include both notification module 364N and survey module 366N.

User interface modules 362, notification modules 364 and survey modules 366 may perform operations described using software, hardware, firmware, or a mixture of hardware, software, and firmware residing in and/or executing at respective computing devices 300. Each of computing devices 300 may execute respective user interface modules 362, notification modules 364, and/or survey modules 366 with multiple processors or multiple devices. Each of computing devices 300 may execute respective user interface modules 362, notification modules 364, and/or survey modules 366 as virtual machines executing on underlying hardware. User interface modules 362, notification modules 364, and/or survey modules 366 may execute as one or more services of an operating system or computing platform. User interface modules 362, notification modules 364, and/or survey modules 366 may execute as one or more executable programs at an application layer of a computing platform.

Computing devices 300 constitute a group of computing devices from which respective users associated with computing devices 300 may interact with, browse, and/or use information or resources available over network 110 or otherwise provided by system 100. For instance, computing device 300A may, at the direction of a user operating computing device 300A, perform one or more searches for information, monitor or check or process the user's personal communications, perform a task, or access other information or resources. Computing device 300A may receive notifications that may be of interest to the user, based on prior browsing history, searches performed, purchase histories, communication information, expressed interests, and/or other information indicating user activity or contextual information associated with the individual users.

Each of computing devices 300 may include a respective user interface device 330A-330N (collectively “user interface devices 330”) that may function as respective input and/or output devices for computing devices 300. User interface devices 330 may be implemented using various technologies. For instance, user interface devices 330 may function as input devices using presence-sensitive input screens, such as resistive touchscreens, surface acoustic wave touchscreens, capacitive touchscreens, projective capacitance touchscreens, pressure sensitive screens, acoustic pulse recognition touchscreens, or another presence-sensitive display technology. In addition, user interface devices 330 may include microphone technologies, infrared sensor technologies, or other input device technology for use in receiving user input.

User interface devices 330 may function as output (e.g., display) devices using any one or more display devices, such as liquid crystal displays (LCD), dot matrix displays, light emitting diode (LED) displays, organic light-emitting diode (OLED) displays, e-ink, or similar monochrome or color displays capable of outputting visible information to a user of computing devices 300. In addition, user interface devices 330 may include speaker technologies, haptic feedback technologies, or other output device technology for use in outputting information to a user.

User interface devices 330 may each include respective presence-sensitive displays that may receive tactile input from a user of respective computing devices 300. User interface devices 330 may receive indications of tactile input by detecting one or more gestures from a user (e.g., the user touching or pointing to one or more locations of user interface devices 330 with a finger or a stylus pen). User interface devices 330 may present output to a user, for instance at respective presence-sensitive displays. User interface devices 330 may present the output as respective graphical user interfaces (e.g., user interface 332 and/or user interface 334), which may be associated with functionality provided by computing devices 300. For example, user interface devices 330 may present various user interfaces (e.g., user interface 332) related to survey functions provided by survey modules 366 or other features of computing platforms, operating systems, applications, and/or services executing at or accessible from computing devices 300 (e.g., electronic message applications, Internet browser applications, mobile or desktop operating systems, etc.).

User interface modules 362 may manage user interactions with respective user interface devices 330 and other components of computing devices 300. User interface modules 362 may cause user interface devices 330 to output respective user interfaces, such as user interface 332 and/or user interface 334 (or other example user interfaces) for display or presentation, as users of computing devices 300 view output and/or provide input at user interface devices 330. User interface modules 362 and user interface devices 330 may receive one or more indications of input from users as the users interact with the user interfaces, at different times and when the users and computing devices 300 are at different locations. User interface modules 362 and user interface devices 330 may interpret inputs detected at user interface devices 330 and may relay information about the inputs detected at user interface devices 330 to one or more associated platforms, operating systems, applications, and/or services executing at computing devices 300, for example, to cause computing devices 300 to perform functions.

User interface modules 362 may receive information and instructions from one or more associated platforms, operating systems, applications, and/or services executing at computing devices 300 and/or one or more remote computing systems, such as computing system 200. In addition, user interface modules 362 may act as intermediaries between the one or more associated platforms, operating systems, applications, and/or services executing at computing devices 300, and various output devices of computing devices 300 (e.g., speakers, LED indicators, audio or electrostatic haptic output device, etc.) to produce output (e.g., a graphic, a flash of light, a sound, a haptic response, etc.) with computing devices 300.

Survey modules 366 may generally perform operations for obtaining survey information associated with electronic surveys that survey modules 366 conduct to elicit responses from users of computing devices 300. Survey modules 366 may be included in one or more or all of computing devices 300. Survey modules 366 may receive survey information over network 110 from computing system 200, and may cause user interface modules 362 to present graphical user interfaces associated with one or more surveys at user interface devices 330. Survey modules 366 may receive indications of input that it determines corresponds to responses to one or more survey questions. Survey modules 366 may transmit information (e.g., answers to survey questions) to computing system 200 over network 110.

In the example of FIG. 1, survey module 366A has caused user interface module 362A to present user interface 332 at user interface device 330A. As further described below, user interface 332 may provide or request information and/or act as an interactive survey. User interface 332 may prompt a user of computing device 300A for survey information (e.g., answers to questions posed in the interactive survey). Such survey content included in user interface 332 may be generated by survey module 266 of computing system 200 and transmitted to computing device 300A over network 110. User interface 332 may include any or all of a variety of types of information and content, and may include various types of graphical indications such as visual depictions of one or more topics, subjects, and/or events associated with a survey. Survey module 366A may cause user interface module 362A of computing device 300A to output user interface 332 based on information survey module 366A (or another module within computing device 300A) receives via network 110 from computing system 200. Survey module 366A may receive graphical information (e.g., text, images data, etc.) for presenting user interface 332 as input from computing system 200 along with instructions from computing system 200 for presenting the graphical information within user interface 332 at user interface device 330A.

Notification modules 364 may perform notification-related functions for computing devices 300. Notification modules 364 may be included in one or more or all of computing devices 300. Computing devices 300 may receive information over network 110 from computing system 200, and notification modules 364 may cause user interface modules 362 to present a graphical user interface that includes one or more notifications alerting users of computing devices 300 as to the receipt of the information. As used herein, a notification may be any type of graphical alert, audible alert, or haptic type (e.g., vibration) alert used by a computing device or computing system to alert a user to information. Such notifications may be targeted notifications, such that one or more of the notifications may be relevant to the interests, context, or needs of a user operating the relevant computing device 300. Notification modules 364 may receive indications of input that it determines corresponds to interactions with one or more notifications, and notification modules 364 may, in response, cause each respective user interface modules 362 to update the graphical user interfaces presented at respective user interface devices 330 and/or transmit information over network 110 to computing system 200. Although notification modules 364 are in some examples described in terms of notifications presented in a graphical user interface, notification modules 364 may in other examples present other types of information, including but not limited to advertisements, commercial messages, promotional information, and/or marketing messages.

In the example of FIG. 1, notification module 364C has caused user interface module 362C to present user interface 334 at user interface device 330C. As further described below, user interface 334 may present targeted information. In some examples, notification module 364C may interact with and/or operate in conjunction with one or more modules of computing system 200. Such targeted information included in user interface 334 may be generated by targeting module 262 of computing system 200 and transmitted to computing device 300C over network 110. User interface 334 may include any or all of a variety of types of information and content, and may include various types of graphical indications such as visual depictions of targeted content. User interface module 362C of computing device 300C may cause user interface device 330C of computing device 300C to output user interface 334 based on information notification module 364C (or another module within computing device 300C) receives via network 110 from computing system 200. Notification module 364C may receive graphical information (e.g., text, images data, etc.) for presenting user interface 334 from computing system 200. Notification module 364C may also receive instructions from computing system 200 for presenting the graphical information within user interface 334 at user interface device 330C.

Although computing devices 300 may be illustrated in FIG. 1 as similar devices, one or more of computing devices 300 may be different from others, and may be implemented through widely diverse hardware, software, and other components. In some examples, some of computing devices 300 may be implemented as one or more smartphones, some of computing devices 300 may be implemented as one or more tablet devices, and some of computing devices 300 may be implemented as other types of devices. Many implementations are possible. Further, some of computing devices 300 may include hardware, modules, software and/or functionality not found in other computing devices 300. In FIG. 1, for example, survey modules 366 and notification modules 364 are shown as included in only some of computing devices 300. In other examples, all of computing devices 300 may include survey modules 366 and notification modules 364. In other examples, all of computing devices 300 may include notification modules 364, but only some of computing devices 300 might include survey modules 366. In still further examples, one or more other modules of computing devices 300 may be included, omitted, combined with other modules, or split into more than one module. Other arrangements are possible and contemplated.

Computing system 200 represents any suitable computing system, such as one or more server computers, desktop computers, laptop computers, mainframes, appliances, cloud computing systems, etc. capable of sending and receiving information both to and from a network, such as network 110. Computing system 200 hosts or provides access to services provided by targeting module 262, search module 264, and survey module 266, each of which are included within computing system 200. Computing devices 300 may communicate with computing system 200 over network 110 to access services provided by targeting module 262, search module 264, and/or survey module 266. In some examples, computing system 200 represents a cloud computing system that provides services to computing devices 300 and other devices or systems.

Targeting module 262, search module 264, and/or survey module 266 may perform operations described in accordance with one or more aspects of the present disclosure using software, hardware, firmware, or a mixture of hardware, software, and/or firmware residing in and/or executing at computing system 200. Computing system 200 may execute targeting module 262, search module 264, and/or survey module 266 with multiple processors or multiple devices. Computing system 200 may execute targeting module 262, search module 264, and/or survey module 266 as virtual machines executing on underlying hardware. Computing system 200 may execute targeting module 262, search module 264, and/or survey module 266 as one or more services of an operating system or computing platform. Computing system 200 may execute targeting module 262, search module 264, and/or survey module 266 as one or more executable programs at an application layer of a computing platform.

Search module 264 may execute searches for information (e.g., available using the Internet) based on search queries search module 264 receives from computing devices 300. For example, computing device 300A may detect input that it determines corresponds to a string of characters representing a search query for information about upcoming television shows. Computing device 300A may transmit the string of characters over network 110 to computing system 200. Search module 264 of computing system 200 may receive an indication of input that it determines corresponds to a search query for information about baseball. Search module 264 may obtain information responsive to the query and transmit the information to computing device 300A over network 110. Search module 264 may maintain one or more search histories corresponding to or organized according to users of computing devices 300.

Targeting module 262 may gather and/or collect information related to computing devices 300 and may provide information to, and/or make determinations based on information available to targeting module 262, which may include information from search module 264 and/or survey module 266. Targeting module 262 may determine interest profiles for one or more users of computing devices 300. For example, interest profiles may be calculated or based on search histories maintained by search module 264. In some examples, search module 264 may provide targeting module 262 with access to the search histories maintained by search module 264. In other examples, search module 264 may analyze the search histories and output information from the search histories on behalf of targeting module 262. Targeting module 262 may incorporate information from the search histories into one or more interest profiles maintained by targeting module 262. For example, in the example described above, search module 264 may output to targeting module 262 information about the search performed by a user of computing device 300A relating to baseball. Targeting module 262 may include “baseball” in an interest profile for a user operating computing device 300A.

The interest profiles maintained by targeting module 262 may also be calculated or based on other information, beyond search histories. For example, targeting module 262 may determine information in an interest profile based on browsing, shopping, or other activity. Targeting module 262 may determine information in an interest profile based on user topics of interest (e.g., a user's favorite “things” typically maintained as a user interest graph or some other type of data structure), contact information associated with users (e.g., a user's personal contact information as well as information about a user's friends, co-workers, social media connections, family, etc.), long and short term tasks, calendar information, application use histories, purchase histories, favorites, bookmarks, and other information that computing devices 300 and computing system 200 may gather about a user of one or more of computing devices 300. Further, targeting module 262 may determine information in an interest profile based on explicit settings received as input from a user and/or indications of input (e.g., by computing devices 300 and/or computing system 200) that targeting module 262 or another module interprets as explicit interest settings by one or more users.

Further, targeting module 262 may gather and/or collect location information associated with one or more computing devices 300 and include location information or information derived from such location information in an interest profile for one or more users of computing devices 300. Targeting module 262 may, for example, determine whether the current location of one or more computing devices 300 coincides with a previous location from a location history of each respective computing devices 300. Targeting module 262 may maintain contextual histories associated with each of computing devices 300 and determine whether a respective, current context associated with one or more of computing devices 300 matches a previous context found in a respective contextual history. For example, targeting module 262 may maintain, as part of an interest profile associated with computing device 300A or a user of computing device 300A, a location history that tracks where computing device 300A was located at a particular day or time. Such location information may include past, current, and future physical locations, degrees of movement, weather and traffic conditions, patterns of travel, and the like.

Further, in some examples, targeting module 262 may gather and/or collect sensor information obtained by one or more sensors (e.g., gyroscopes, accelerometers, proximity sensors, etc.) of computing devices 300, radio transmission information obtained from one or more communication units and/or radios (e.g., global positioning system (GPS), cellular, Wi-Fi, etc.) of computing devices 300, information obtained by one or more input devices (e.g., cameras, microphones, keyboards, touchpads, mice, user interface devices 330, etc.) of computing devices 300, and network/device identifier information (e.g., a network name, a device internet protocol address, etc.) of computing devices 300. Targeting module 262 may include sensor information from or information derived from sensor information in an interest profile for one or more users of computing devices 300.

Furthermore, targeting module 262 may gather and/or collect information about the operating state of one or more of computing devices 300, and targeting module 262 may include such information or information derived from such information in an interest profile for one or more of computing devices 300. For example, an application that is executed at a given time or in a particular location is an example of information about the operating state of a computing device. Other examples may include, but are not limited to, positions of switches, battery levels, whether a device is plugged into a wall outlet or otherwise operably coupled to another device and/or machine, user authentication information (e.g., which user), whether a device is operating in “airplane” mode, in standby mode, in full-power mode, the operational state of radios, communication units, input devices and output devices, etc.

Targeting module 262 may continuously update the information it collects and maintains in interest profiles for users of computing devices 300 as targeting module 262 receives new and updated information. For instance, targeting module 262 may receive further browsing information associated with computing device 300A from search module 264 and use such information to update the interest profile maintained for a user of computing device 300A. Further, targeting module 262 may receive updated movement information gathered by sensors of computing device 300A and use the movement information to update the interest profile for a user of computing device 300A.

The types of information that may be included in interest profiles maintained by targeting module 262 may include any conceivable information that may be used by a computing system or a computing device, such as computing system 200 and/or computing devices 300, to determine one or more behavioral, environmental, and/or contextual characteristics associated with a computing device and/or a user. The interest profiles maintained by targeting module 262 may be sortable and/or searchable so that targeting module 262 may analyze the interest profiles for one or more users of computing devices 300.

Targeting module 262 may associate interest profiles with users of computing devices 300, rather than with computing devices 300 themselves (although both approaches, as well as others, are possible). In some examples, a user of one of computing devices 300 may establish a session that may identify or associate a particular user with operations performed by a particular computing device 300 for a period of time. In such examples, computing device 300A may issue one or more authentication challenges or a username/password prompts. Based on input responsive to such challenges and/or prompts, computing device 300A may determine the identity of the user operating computing device 300A. Thereafter, computing device 300A may include information sufficient to identify the user when some or all network operations are performed by computing device 300A. For example, when computing device 300A communicates with computing system 200 (or another device over network 110) to perform a search, computing device 300A may include in its communication with computing system 200 information sufficient to identify the user operating computing device 300A. If that same user later operates computing device 300C, for example, searches performed by that user at computing device 300C may also be associated with the identified user. Computing system 200 may therefore associate information derived from that user's searches at both computing device 300A and computing device 300C with a single interest profile associated with that user.

In some examples, interests included in interest profiles for users of computing devices 300 may be related to entities, such as people, organizations, objects, topics, media, or events. Such interest profiles may include interests categorized, classified, and/or grouped as entities, and in such an example, an interest profile may include references to explicit entities identifying people (e.g. a popular musician, politician, sports figure), organizations (e.g., a charitable organization, corporate entity, a political group, sports team), topics (baseball, politics), objects (computers, bicycles), media (a popular movie or song), events (holidays, sporting events, political events, business events, entertainment events), or other entities. In some examples, interests included in an interest profile may be considered or alternatively described as calculated interests.

Targeting module 262 may, based at least in part on the information it collects and/or maintains in interest profiles, send a notification, information set, data, promotional information, advertising content, marketing messages, or other information to one or more computing devices 300. Such information may be targeted information that targeting module 262 has chosen or determined to be relevant to interests included in an interest profile for a user operating one or more of computing devices 300. For example, targeting module 262 may send a notification to computing device 300C that is chosen by targeting module 262 to be relevant to one or more identified interests or interest profile entities of a user of computing device 300C. Notification module 364C may receive an indication of input that it determines corresponds to a notification. Notification module 364C may cause user interface module 362C to present user interface 334 at user interface device 330C as illustrated in FIG. 1.

Survey module 266 may perform survey-related functions for computing system 200. For example, computing system 200 may, either automatically, or at the direction of a user of computing system 200, generate survey information for inclusion in a survey to be distributed to one or more computing devices 300. Survey module 266 may transmit one or more surveys to some or all of computing devices 300. In some examples, survey module 266 may interact with survey modules 366 at one or more computing devices 300. In other examples, survey module 266 may distribute and/or conduct surveys of users of computing devices 300 that do not include survey modules 366.

Survey module 266 may send over network 110 surveys or survey information to one or more computing devices 300, and may receive from one or more computing devices 300 over network 110 survey response information. Survey module 266 may analyze the survey response information to determine survey results. Survey module 266 may cause one or more users of computing devices 300 to receive compensation in return for providing responses to survey questions. Such compensation may be in the form of cash, credit for future purchases, and/or access to content (e.g., free access to content otherwise behind a pay wall or other premium content). Survey module 366 included within one or more of computing devices 300 may facilitate or perform operations relating to compensation for survey responses.

Throughout the disclosure, examples are described where a computing device and/or a computing system analyzes information (e.g., interest profiles, survey responses, context, locations, speeds, search queries, etc.) associated with a computing device and a user of a computing device, only if the computing device receives permission from the user of the computing device to analyze the information. For example, in situations described or discussed in this disclosure, before computing system 200 or one or more computing devices 300 collect or may make use of information associated with a user, the user may be provided with an opportunity to provide input to control whether programs or features of computing system 200 and/or one or more computing devices 300 can collect and make use of user information (e.g., interest profiles, search information, survey information, information about a user's current location, current speed, etc.), or to dictate whether and/or how to the device and/or system may receive content that may be relevant to the user. In addition, certain data may be treated in one or more ways before it is stored or used by computing system 200 and/or computing devices 300, so that personally-identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, the user may have control over how information is collected about the user and used by computing system 200 and/or computing devices 300.

In accordance with one or more aspects of the present disclosure, computing system 200 may determine one or more users that may be interested in a particular upcoming event. Computing system 200 may conduct a survey of a subset of users of computing devices 300 to identify one or more users that express interest in the upcoming event. Computing system 200 may, based on the results of the survey, identify one or more other users of computing devices 300 that were not included in the survey, who are also likely to be interested in the upcoming event. Computing system 200 may send information to those identified users of computing devices 300 over network 110.

For example, computing system 200 may access data and recognize an upcoming event, such as a popular international sporting event. In some examples, the upcoming event may be an event that happens infrequently, such as one per year or less often. For example, the international sporting event could be an event that occurs every four years and that brings together many nations to compete in a variety of events. For purposes of discussion, such an event may be referred to herein as the “International Sporting Event.” Often, interest profiles might not commonly include an entity or concept that directly relates to such infrequently-occurring events. For such events, a user may show behavior that suggests interest in the International Sporting Event while the International Sporting Event is taking place, and a system, such as computing system 200, may include an interest relating to the International Sporting Event in an interest profile for that user. But because the International Sporting Event takes place infrequently, a user might not consistently exhibit behavior suggesting an interest in the International Sporting Event, and periods of more than a year may transpire without the user exhibiting any apparent interest in the International Sporting Event. In some examples, computing system 200 might interpret this as the user's interest in the International Sporting Event dissipating (regardless as to whether the user's interest in the event is actually dissipating), and that user's interest profile may be modified by computing system 200 to drop entities or topics relating to the International Sporting Event from that user's interest profile. As a result, many interest profiles associated with users that are interested in the International Sporting Event might not include information explicitly suggesting interest in the International Sporting Event.

Survey module 266 of computing system 200 may conduct a survey by polling one or more users of computing devices 300 about their interest in the International Sporting Event. For example, Survey module 266 may generate a survey, and may distribute the survey over network 110 to a subset of computing devices 300. In some examples, one or more computing devices 300, including each computing device 300 in the subset, may include survey modules 366. In such an example, survey module 266 of computing system 200 may communicate with the subset of users of computing devices 300 by interacting with survey modules 366 over network 110.

In the example of FIG. 1, survey module 366A of computing device 300A may receive information from survey module 266 of computing system 200, and survey module 366A of computing device 300A may cause user interface module 362A to present user interface 332 at user interface device 330A. Survey module 366A may receive one or more indications of input that it determines corresponds to a user response to the survey presented by user interface 332. Survey module 366A may send information about the response to survey module 266 of computing system 200 over network 110. Other survey modules 366 may cause other user interface devices 330 of computing devices 300 to present a graphical user interface similar to user interface 332. Survey modules 366 for such other computing devices 300 may determine survey results for computing devices 300 and each may send the survey results for a user to survey module 266 of computing system 200 over network 110. Survey module 266 may output information about the survey results received from the subset of computing devices 300 to targeting module 262.

Targeting module 262 may analyze the survey results received from computing device 300A and other computing devices 300. Targeting module 262 may, based on the information about the survey results, identify those users having a high amount of interest in the target event that was the subject of the survey (e.g., “this year's International Sporting Event”). In some examples, users responding as either “interested” or “very interested” (responses 4 or 5) may be considered to have a high amount of interest in the target event.

Targeting module 262 may determine, based on the information about the survey results, one or more interests or entities that are correlated with or suggest high interest in receiving information about the International Sporting Event. In some examples, targeting module 262 may calculate, for each interest or entity associated with a user operating one of the surveyed computing devices 300, the percentage of surveyed users that expressed high interest in the International Sporting Event from the total number of surveyed users. For instance, the survey information may indicate that one hundred surveyed users had the interest “sports” in their interest profile. The survey information may further indicate that of those one hundred users, thirty-nine of them responded to the survey question (e.g., as illustrated in user interface 332) with high interest. Accordingly, targeting module 262 may determine that thirty-nine percent of the total number of surveyed users having the interest “sports” in their interest profile responded to the survey question with high interest. Similarly, targeting module 262 may determine that ten percent of the total number of surveyed users having “art” in their interest profile responded to the survey question with high interest. Further, targeting module 262 may determine that fifty-nine percent of the total number of surveyed users having the interest “college football” in their interest profile responded to the survey question with high interest. Targeting module 262 may rank the user interests based on these percentages, and determine that having “college football” in an interest profile suggests interest in the International Sporting Event, and that “college football” may therefore be a good targeting criterion for interest in the International Sporting Event. Targeting module 262 may determine that the user interest “art” might not be a good targeting criteria for interest in the International Sporting Event. In other examples, targeting module 262 may determine that none of the identified interests sufficiently suggest interest in the International Sporting Event.

Targeting module 262 may identify other computing devices 300 that are associated with or operated by users having the user interest “college football” in their interest profile. In most examples, such other computing devices 300 might not be part of the surveyed group of computing devices 300, although in some examples, such other computing devices 300 could be part of the surveyed group. In the example of FIG. 1, targeting module 262 may determine that the user operating computing device 300C has “college football” in his or her interest profile. As a result, even though the user associated with computing device 300C may not have indicated (either via the electronic survey or previously in his or her interest profile) an interest in the International Sporting Event, targeting module 262 may access or generate a notification about the International Sporting Event and output the notification for transmission over network 110 in response to inferring an interest in the International Sporting Event, given his or her interest in “college football”.

Notification module 364C of computing device 300C may receive an indication of the notification, and may cause user interface module 362C to present user interface 334 at user interface device 330C. As shown, user interface 334 illustrates a notification that includes times for upcoming events in the International Sporting Event. The information presented in user interface 334 may be viewed as useful and/or appreciated information by a user of computing device 300C. In some examples, user interface module 362C may also or alternatively cause computing device 300C to output an audio, physical, or other notification to indicate to the user that useful information may be available at user interface device 330C.

The information presented or output by computing device 300C may take the form of a notification (e.g., as in user interface 334), but information presented by computing device 300C or other computing devices 300 may take other forms. For example, user interface 334 may include or may be part of an advertisement, commercial message, promotion information, or marketing message or information. Further, information presented or output by computing device 300C could be part of, or may include, an email, search results, and/or an application. The targeting capabilities in accordance with one or more aspects of this disclosure may take many forms and may be used in many ways. Further, although one or more example(s) described in this disclosure may contemplate targeting and/or providing information about an upcoming event, in other examples, system 100 may provide information about a topic, person, concept, entity, past event, or other subject. Further, in some examples, targeting module 262 may determine that none of the identified interests sufficiently suggest interest in the International Sporting Event, and in such an example, targeting module 262 of computing system 200 may refrain from accessing, generating, accessing, and/or outputting information based on the identified interests.

Accordingly, by using, in the manner described, empirical or survey information when identifying users that may be interested in an upcoming event, computing system 200 may be able to avoid sending information about an upcoming event to too many users, particularly those users who are not interested in the event. Consequently, computing system 200 may avoid distracting users who are not interested in the information, and also, computing system 200 may avoid wasting users' time by sending information that users do not want to receive. Further, by not sending information to users who are not interested in the information, computing system 200 may perform less operations, and as a result, consume less electrical power. Also, by not sending information to users who are not interested in the information, computing system 200 may perform less network operations, and as a result consume less network resources.

Further, by using empirical or survey information when identifying users that may be interested in an upcoming event, computing system 200 may be more likely to identify, rather than fail to identify, users who are interested in receiving information about the upcoming event. Accordingly, computing system 200 may be more likely to provide information to users that need, desire, appreciate, or may otherwise benefit from the information. Also, computing system 200 may also be able to prevent extra work by a user or by one or more computing devices 300. For example, if a user of computing device 300C will eventually seek information about upcoming events in the International Sporting Event, it is easier, from that user's perspective, to receive the information in an automated way without having to ask for it. Further, computing device 300C may perform less computing and network operations by providing the information without requiring input requesting the information, at least because computing and network operations required to process input by the user may be avoided. Accordingly, if computing device 300 performs less computing operations, computing device 300 may consume less electrical power. And if computing device 300 performs less network operations, less data may be transmitted over the network, thereby having less of an impact on network resources or congestion.

Still further, by using survey information to identify interests or entities that may be correlated to high interest in an event, and incorporating such information into a targeting algorithm, computing system 200 may be able accurately identify users interested in an event in an automated way. As a result, other efforts to determine appropriate targeting criteria, such as those performed by marketing personnel, can be avoided. Such efforts by marketing or other personnel are not only subjective, time-consuming, and expensive, but such efforts are often ultimately inaccurate, because some targeting criteria may be counterintuitive or difficult to anticipate. Such efforts may be even more difficult for events that are infrequent or ephemeral, since calculated interests (e.g., based on search or browsing activity) that directly relate to such events may be rare.

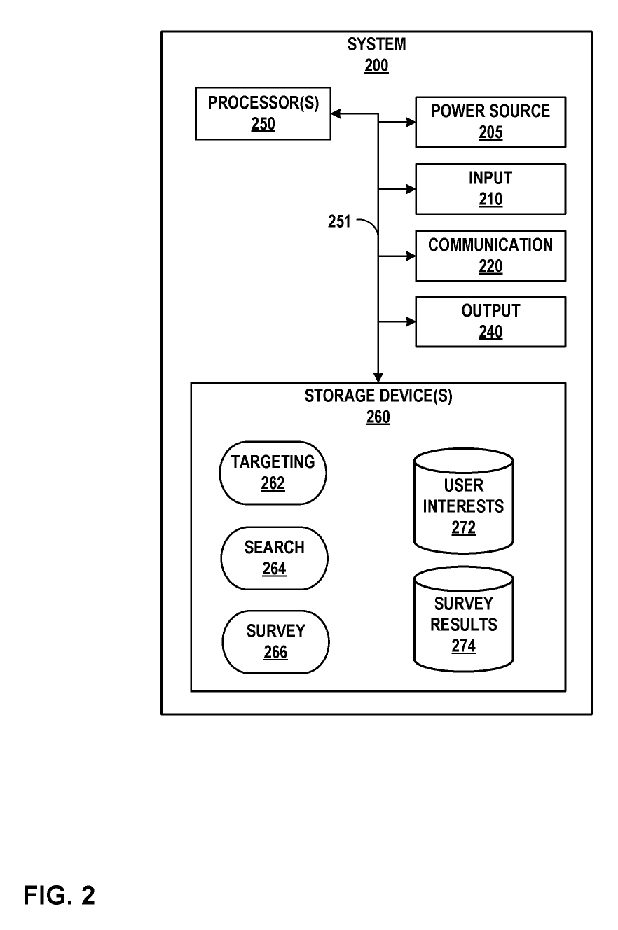

FIG. 2 is a block diagram illustrating an example computing system that is configured to identify users that may interested in an upcoming event, in accordance with one or more aspects of the present disclosure. Computing system 200 of FIG. 2 is described below as an example or alternate implementation of computing system 200 of FIG. 1. However, FIG. 2 illustrates only one particular example or alternate implementation of computing system 200, and many other example or alternate implementations of computing system 200 may be used or may be appropriate in other instances. Such implementations may include a subset of the components included in the example of FIG. 2 or may include additional components not shown in the example of FIG. 2. Although computing system 200 of FIG. 2 may be a stand-alone device, computing system 200 may, generally, take many forms, and may be, or may be part of, any component, device, or system that includes a processor or other suitable computing environment for processing information or executing software instructions. In some examples, computing system 200 may be fully implemented as hardware in one or more devices or logic elements.

Computing system 200 of FIG. 2 includes power source 205, one or more input devices 210, one or more communication units 220, one or more output devices 240, one or more processors 250, and one or more storage devices 260. Communication channels 251 may interconnect each of the components of FIG. 2 for inter-component communications (physically, communicatively, and/or operatively). In some examples, communication channels 251 may include a system bus, a network connection, an inter-process communication data structure, or any other method for communicating data.

One or more input devices 210 of computing system 200 may generate, receive, or process input. Such input may include input from a keyboard, pointing device, voice responsive system, video camera, button, sensor, mobile device, control pad, microphone, presence-sensitive screen, network, or any other type of device for detecting input from a human or machine.

One or more output devices 240 of computing system 200 may generate, receive, or process output. Examples of output are tactile, audio, visual, and/or video output. Output devices 240 may include a display, sound card, video graphics adapter card, speaker, presence-sensitive screen, one or more USB interfaces, video and/or audio output interfaces, or any other type of device capable of generating tactile, audio, video, or other output. A display output device may include a cathode ray tube (CRT) monitor, liquid crystal display (LCD), Light-Emitting Diode (LED) display, or any other type of display device.

One or more communication units 220 of computing system 200 may communicate with devices external to computing system 200 by transmitting and/or receiving data, and may operate, in some respects, as both an input device and an output device. In some examples, communication units 220 may communicate with other devices over a network. In other examples, communication units 220 may send and/or receive radio signals on a radio network such as a cellular radio network. In other examples, communication units 220 of computing system 200 may transmit and/or receive satellite signals on a satellite network such as a Global Positioning System (GPS) network. Examples of communication units 220 include a network interface card (e.g. such as an Ethernet card), an optical transceiver, a radio frequency transceiver, a GPS receiver, or any other type of device that can send and/or receive information. Other examples of communication units 220 may include Bluetooth®, GPS, 3G, 4G, and Wi-Fi® radios found in mobile devices as well as Universal Serial Bus (USB) controllers and the like.

Power source 205 may provide power to one or more components of computing system 200. Power source 205 may receive power from the primary alternative current (AC) power supply in a building, home, or other location. In other examples, power source 205 may be a battery. In still further examples, computing system 200 and/or power source 205 may receive power from another source. Power source 205 may have intelligent power management or consumption capabilities, and may such features may be controlled, accessed, or adjusted by one or more modules of computing system 200 and/or by processor(s) 250 to intelligently consume, allocate, supply, or otherwise manage power.

One or more processors 250 may implement functionality and/or execute instructions associated with computing system 200. Examples of processors 250 include microprocessors, application processors, display controllers, auxiliary processors, one or more sensor hubs, and any other hardware configured to function as a processor, a processing unit, or a processing device. Computing system 200 may use one or more processors 250 to perform operations in accordance with one or more aspects of the present disclosure using software, hardware, firmware, or a mixture of hardware, software, and firmware residing in and/or executing at computing system 200.

One or more storage devices 260 include targeting module 262, search module 264, and survey module 266. Targeting module 262, search module 264, and survey module 266 may include the same capability as in FIG. 1. In other examples, targeting module 262, search module 264, and survey module 266 may include capabilities different than those of FIG. 1. Storage devices 260 further include user interests data store 272 and survey results data store 274.

One or more storage devices 260 within computing system 200 may store information for processing during operation of computing system 200. In some examples, one or more storage devices 260 are temporary memories, meaning that a primary purpose of the one or more storage devices is not long-term storage. Storage devices 260 on computing system 200 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 260, in some examples, also include one or more computer-readable storage media. Storage devices 260 may be configured to store larger amounts of information than volatile memory. Storage devices 260 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Storage devices 260 may store program instructions and/or data associated with one or more of the modules described in accordance with one or more aspects of this disclosure.

One or more processors 250 and one or more storage devices 260 may provide an operating environment or platform for one or one more modules, which may be implemented as software, but may in some examples include any combination of hardware, firmware, and software. One or more processors 250 may execute instructions and one or more storage devices 260 may store instructions and/or data of one or more modules. The combination of processors 250 and storage devices 260 may retrieve, store, and/or execute the instructions and/or data of one or more applications, modules, or software. Processors 250 and/or storage devices 260 may also be operably coupled to one or more other software and/or hardware components, including, but not limited to, one or more of the components illustrated in FIG. 2.

User interests data store 272 may represent any suitable storage medium for storing information related to user interests (e.g., browsing history, search history, profile data, activity data) or interest profiles. The information stored in user interests data store 272 may be searchable and/or categorized such that one or more modules within storage device 260 may provide an input requesting information from user interests data store 272, and in response to the input, receive information stored within user interests data store 272.

User interests data store 272 may be primarily maintained by targeting module 262 and may store interest profiles or similar information for one or more users of computing devices 300 of FIG. 1. User interests data store 272 may receive from targeting module 262 information identifying an interest for one or more users of computing devices 300, based on search history, browsing history, or other activity of one or more computing devices 300 and/or users for one or more computing devices 300. User interests data store 272 may receive from search module 264 information identifying an interest for one or more users of computing devices 300 based on search history. User interests data store 272 may receive from survey module 266 survey result information for one or more users of computing devices 300. User interests data store 272 may provide targeting module 262 with access to the data stored within user interests data store 272, and/or may analyze the data stored within user interests data store 272 and output such information on behalf of targeting module 262 and/or other modules.

Survey results data store 274 may represent any suitable storage medium for storing information related to survey results (e.g., questions posed, answers, users polled, time polled). The information stored in survey results data store 274 may be searchable and/or categorized such that one or more modules within storage device 260 may provide an input requesting information from survey results data store 274, and in response to the input, receive information stored within survey results data store 274.

Survey results data store 274 may be primarily maintained by survey module 266 and may store survey information for one or more users of computing devices 300 of FIG. 1. Survey results data store 274 may receive from survey module 266 survey result information for one or more users of computing devices 300. Survey results data store 274 may provide targeting module 262, survey module 266, and/or other modules with access to the data stored within survey results data store 274, and/or may analyze the data stored within survey results data store 274 and output such information on behalf of targeting module 262, survey module 266 and/or other modules.

Although certain modules, data stores, components, programs, executables, data items, functional units, and/or other items included within storage device 260 may have been illustrated separately, one or more of such items could be combined and operate as a single module, component, program, executable, data item, or functional unit. For example, one or more modules or data stores may be combined or partially combined so that they operate or provide functionality as a single module. Further, one or more modules may operate in conjunction with one another so that, for example, one module acts as a service or an extension of another module. Also, each module, data store, component, program, executable, data item, functional unit, or other item illustrated within storage device 260 may include multiple components, sub-components, modules, sub-modules, data stores, and/or other components or modules or data stores not illustrated. Further, each module, data store, component, program, executable, data item, functional unit, or other item illustrated within storage device 260 may be implemented in various ways. For example, each module, data store, component, program, executable, data item, functional unit, or other item illustrated within storage device 260 may be implemented as a downloadable or pre-installed application or “app.” In other examples, each module, data store, component, program, executable, data item, functional unit, or other item illustrated within storage device 260 may be implemented as part of an operating system executed on computing system 200.

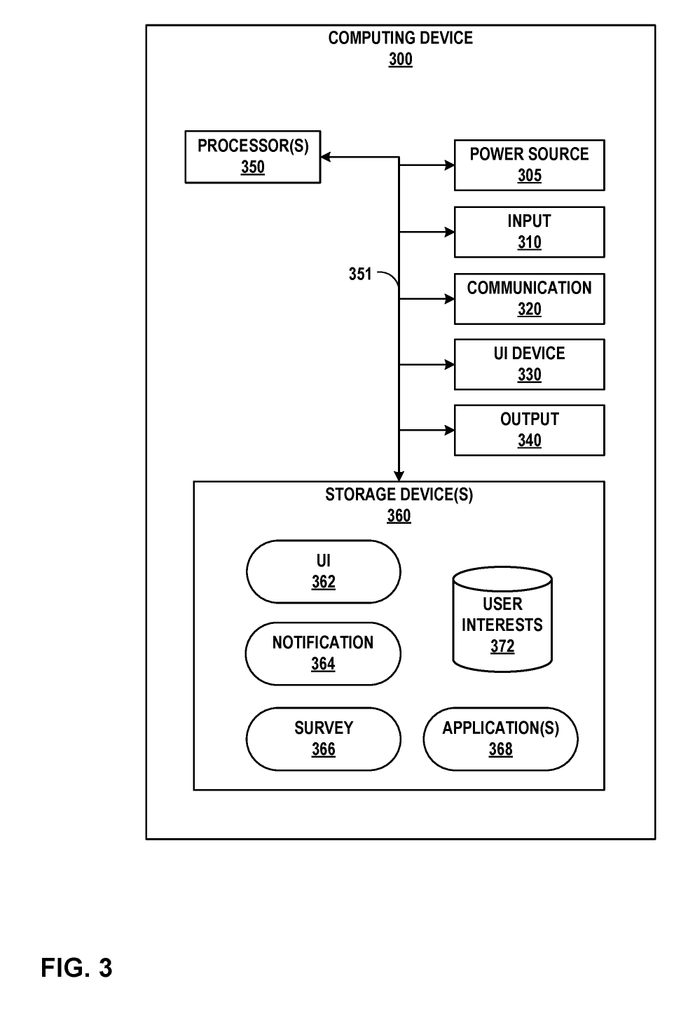

FIG. 3 is a block diagram illustrating an example computing device that is configured to operate in accordance with one or more aspects of the present disclosure. Computing device 300 of FIG. 3 is described below as an example or alternate implementation of one or more computing devices 300 of FIG. 1. However, FIG. 3 illustrates only one particular example or alternate implementation of computing device 300, and many other example or alternate implementations of computing device 300 may be used or may be appropriate in other instances. Such implementations may include a subset of the components included in the example of FIG. 3 or may include additional components not shown in the example of FIG. 3. Although computing device 300 of FIG. 3 may be a stand-alone device, computing device 300 may, generally, take many forms, and may be, or may be part of, any component, device, or system that includes a processor or other suitable computing environment for processing information or executing software instructions. In some examples, computing device 300 may be fully implemented as hardware in one or more devices or logic elements.

Computing device 300 of FIG. 3 includes power source 305, one or more input devices 310, one or more communication units 320, one or more user interface devices 330, one or more output devices 340, one or more processors 350, and one or more storage devices 360. Communication channels 351 may interconnect each of the components of FIG. 3 for inter-component communications (physically, communicatively, and/or operatively). In some examples, communication channels 351 may include a system bus, a network connection, an inter-process communication data structure, or any other method for communicating data.

One or more input devices 310 may generate, receive, or process input. Such input may include input from a keyboard, pointing device, voice responsive system, video camera, button, sensor, mobile device, control pad, microphone, presence-sensitive screen, network, or any other type of device for detecting input from a human or machine.

One or more output devices 340 may generate, receive, or process output. Examples of output are tactile, audio, visual, and/or video output. Output devices 340 may include a display, sound card, video graphics adapter card, speaker, presence-sensitive screen, one or more USB interfaces, video and/or audio output interfaces, or any other type of device capable of generating tactile, audio, video, or other output. A display output device may include a cathode ray tube (CRT) monitor, liquid crystal display (LCD), Light-Emitting Diode (LED) display, or any other type of display device.

One or more communication units 320 may communicate with devices external to computing device 300 by transmitting and/or receiving data, and may operate, in some respects, as both an input device and an output device. In some examples, communication units 320 may communicate with other devices over a network. In other examples, communication units 320 may send and/or receive radio signals on a radio network such as a cellular radio network. In other examples, communication units 320 of computing device 300 may transmit and/or receive satellite signals on a satellite network such as a Global Positioning System (GPS) network. Examples of communication units 320 include a network interface card (e.g. such as an Ethernet card), an optical transceiver, a radio frequency transceiver, a GPS receiver, or any other type of device that can send and/or receive information. Other examples of communication units 320 may include Bluetooth®, GPS, 3G, 4G, and Wi-Fi® radios found in mobile devices as well as Universal Serial Bus (USB) controllers and the like.

User interface device 330 may function as one or more output (e.g., display) devices, and may be implemented in a manner consistent with the description associated with FIG. 1. In other examples, user interface device 330 of FIG. 3 may be implemented in a manner different than that described in connection with FIG. 1.

Power source 305 may provide power to one or more components of computing device 300. In many examples, power source 305 may be a battery. In other examples, power source 305 may receive power from the primary alternative current (AC) power supply in a building, home, or other location. In still further examples, computing device 300 and/or power source 305 may receive power from another source. Power source 305 may have intelligent power management or consumption capabilities, and may such features may be controlled, accessed, or adjusted by one or more modules of computing device 300 and/or by processor(s) 350 to intelligently consume, allocate, supply, or otherwise manage power.

One or more processors 350 may implement functionality and/or execute instructions associated with computing device 300. Examples of processors 350 include microprocessors, application processors, display controllers, auxiliary processors, one or more sensor hubs, and any other hardware configured to function as a processor, a processing unit, or a processing device. Computing device 300 may use one or more processors 350 to perform operations in accordance with one or more aspects of the present disclosure using software, hardware, firmware, or a mixture of hardware, software, and firmware residing in and/or executing at computing device 300.

One or more storage devices 360 may include user interface module 362, notification module 364, and survey module 366. User interface module 362, notification module 364, and survey module 366 may include the same capability as in FIG. 1. In other examples, user interface module 362, notification module 364, and survey module 366 may include capabilities different than those of FIG. 1. Storage devices 360 further include application modules 368 and user interests data store 372.

One or more storage devices 360 within computing device 300 may store information for processing during operation of computing device 300. In some examples, one or more storage devices 360 are temporary memories, meaning that a primary purpose of the one or more storage devices is not long-term storage. Storage devices 360 on computing device 300 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Storage devices 360, in some examples, also include one or more computer-readable storage media. Storage devices 360 may be configured to store larger amounts of information than volatile memory. Storage devices 360 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Storage devices 360 may store program instructions and/or data associated with one or more of the modules described in accordance with one or more aspects of this disclosure.

One or more processors 350 and one or more storage devices 360 may provide an operating environment or platform for one or one more modules, which may be implemented as software, but may in some examples include any combination of hardware, firmware, and software. One or more processors 350 may execute instructions and one or more storage devices 360 may store instructions and/or data of one or more modules. The combination of processors 350 and storage devices 360 may retrieve, store, and/or execute the instructions and/or data of one or more applications, modules, or software. Processors 350 and/or storage devices 360 may also be operably coupled to one or more other software and/or hardware components, including, but not limited to, one or more of the components illustrated in FIG. 3.

One or more application modules 368 may represent some or all of the other various individual applications and/or services executing at and accessible from computing device 300. A user of computing device 300 may interact with a graphical user interface associated with one or more application modules 368 to cause computing device 300 to perform a function. Numerous examples of application modules 368 may exist and may include web browsing, search, communication, and shopping applications, and any and all other applications that may execute at computing device 300.

User interests data store 372 may represent any suitable storage medium for storing information related to user interests (e.g., browsing history, search history, profile data, activity data) or interest profiles. The information stored in user interests data store 372 may be searchable and/or categorized such that one or more modules within storage device 360 may provide an input requesting information from user interests data store 372, and in response to the input, receive information stored within user interests data store 372. In some examples, computing device 300 may store interest profile information locally for one or more users of computing device 300 of FIG. 3. User interests data store 372 may receive from one or more other modules and/or devices information identifying an interest for one or more users of computing device 300, based on search history, browsing history, or other activity of computing device 300 and/or users of computing device 300. User interests data store 372 may provide one or more modules of computing device 300 with access to the data stored within user interests data store 372, and/or may analyze the data stored within user interests data store 372 and output such information on behalf of one or more modules of computing device 300. User interests data store 372 may provide computing system 200 with access to the data stored within user interests data store 372, and/or may analyze the data stored within user interests data store 372 and output such information on behalf of computing system 200.

Although certain modules, data stores, components, programs, executables, data items, functional units, and/or other items included within storage device 360 may have been illustrated separately, one or more of such items could be combined and operate as a single module, component, program, executable, data item, or functional unit. For example, one or more modules or data stores may be combined or partially combined so that they operate or provide functionality as a single module. Further, one or more modules may operate in conjunction with one another so that, for example, one module acts as a service or an extension of another module. Also, each module, data store, component, program, executable, data item, functional unit, or other item illustrated within storage device 360 may include multiple components, sub-components, modules, sub-modules, data stores, and/or other components or modules or data stores not illustrated. Further, each module, data store, component, program, executable, data item, functional unit, or other item illustrated within storage device 360 may be implemented in various ways. For example, each module, data store, component, program, executable, data item, functional unit, or other item illustrated within storage device 360 may be implemented as a downloadable or pre-installed application or “app.” In other examples, each module, data store, component, program, executable, data item, functional unit, or other item illustrated within storage device 360 may be implemented as part of an operating system executed on computing device 300.

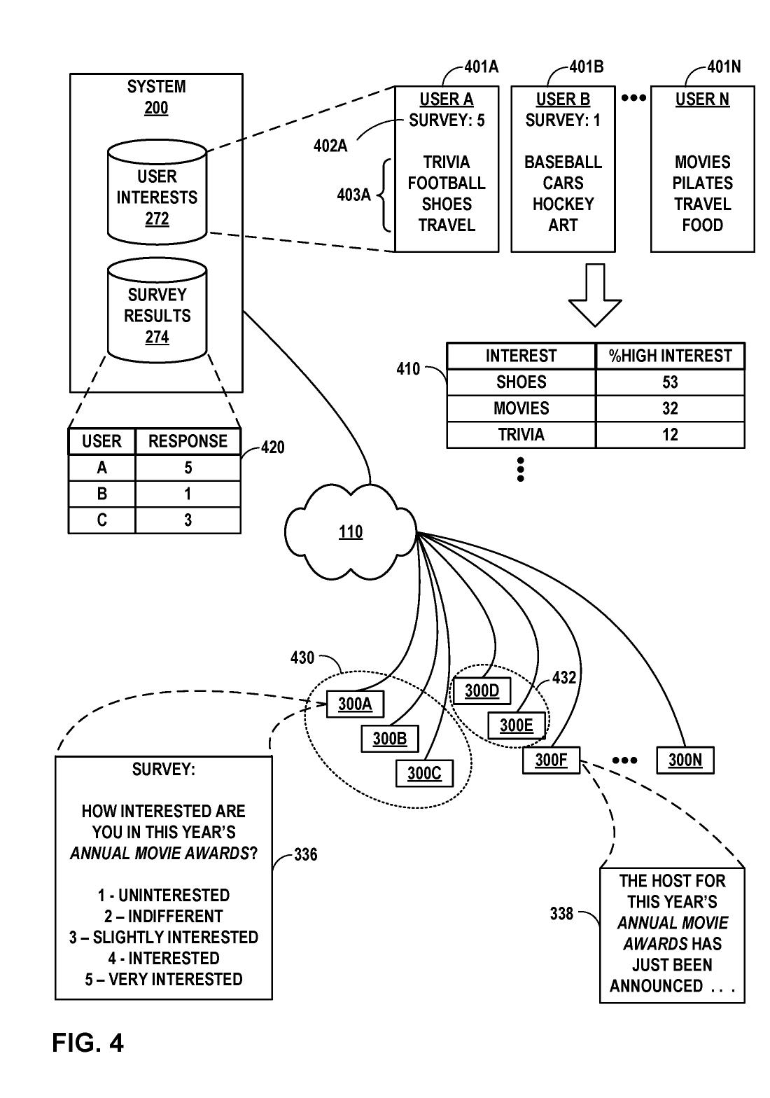

FIG. 4 is a conceptual diagram illustrating an example computing system that is configured to identify users that may be interested in an upcoming event, in accordance with one or more aspects of the present disclosure. One or more aspects of FIG. 4 may be described below within the context of FIG. 1, FIG. 2, and FIG. 3. The example of FIG. 4 includes computing system 200, which may be an example and/or alternative implementation of computing system 200 of FIG. 1 and/or FIG. 2. FIG. 4 further includes multiple computing devices 300, one or more of which may be example and/or alternative implementations of one or more computing devices 300 of FIG. 1 and/or FIG. 3. Computing system 200 and computing devices 300 may communicate over network 110, which may also be implemented in the manner described in connection with FIG. 1, or in other examples, network 110 may be implemented differently.

In the example of FIG. 4, computing system 200 may create user interests data store 272 based on activity by computing devices 300 that is detected or otherwise determined by computing system 200. Such activity of computing devices 300 may include browsing activity, search activity, or other activity. User interests data store 272 may include a record for each of many users. In the example of FIG. 4, user interest profile record 401A, user interest profile record 401B, and user interest profile record 401N are illustrated (collectively, “user interest profile records 401”), corresponding to profile information for user A, user B, through user N, respectively. Included within each user interest profile record 401 may be a survey response 402A-402N (collectively “survey responses 402”) and an interest profile entity listing 403A-402N (collectively “interest profile entity listings 403”). For example, user interest profile record 401A includes survey response 402A and interest profile entity listing 403A. In the example of FIG. 4, user interest profile record 401A includes the survey response provided by user A, detected by computing device 300A, and communicated by computing device 300A over network 110 to computing system 200. Interest profile entity listing 403A includes information determined based on information and/or activity by computing device 300A or by one or more other devices operated by user A. User interest profile record 401B may include survey response 402B and interest profile entity listing 403B. Some user interest profile records 401 might not include a survey response, however, if the user associated with such a user interest profile record was not surveyed (e.g., see user interest profile records 401N).

Computing system 200 may create survey results data store 274 based on survey responses detected at computing devices 300 and communicated by computing devices 300 over network 110 to computing system 200. Survey results information 420 illustrates a conceptual table of responses by users operating one or more of computing devices 300; survey results information 420 may be generated by computing system 200 based on information in survey results data store 274. Although shown for purposes of illustration as a table, computing system 200 may use any suitable data type or data structure for storing and maintaining information survey results information 420. In the example shown, the responses listed in survey results information 420 may correspond to survey responses 402 of user interest profile records 401 (e.g., user A is associated with a “5” response, user B is associated with a “1” response).

One or more computing devices 300 (e.g., computing device 300A, computing device 300B, computing device 300C, computing device 300D) may perform operations by transmitting and receiving information over network 110. Such operations may include web browsing, shopping, searching, and communicating. Computing system 200 may detect, identify, and/or determine some or all of such activity and create interest profile entity listings 403 for each of the users of computing devices 300. Based on such activity, computing system 200 may determine at least some of the information included in user interest profile records 401.

Computing system 200 may identify or determine an upcoming event, such as an annual awards show, which may be referred to herein as the “Annual Movie Awards” show. Computing system 200 may identify or determine the Annual Movie Awards show based on information available to computing system 200 or based on input received by computing system 200.

Computing system 200 may generate and conduct a survey among computing device subset 430 of computing devices 300. For ease of illustration, computing device subset 430 of FIG. 4 is illustrated as including only computing device 300A, computing device 300B, and computing device 300C, but computing device subset 430 in most cases will include many more computing devices 300. In many examples, computing device subset 430 will be much larger, and may include many more computing devices 300, and may include a sufficient number of computing devices 300 so that a survey of computing device subset 430 produces statistically significant results. To conduct the survey, computing system 200 may communicate with computing devices 300 of computing device subset 430. For example, computing system 200 may send survey information over network 110 to computing device 300A. Computing device 300A may receive the survey information, and in response, generate and display user interface 336. Computing device 300A may detect input that it determines corresponds to a response to the survey information presented by user interface 336. Computing device 300A may communicate information about the response over network 110 to computing system 200. Computing system 200 may process the information, and update survey results data store 274. In the example of FIG. 4, survey results information 420 shows that the operator of computing device 300A (e.g., user A) has responded to the question presented by user interface 336 with a “5” response (i.e., “very interested”). Computing system 200 may similarly interact with each of computing devices 300 within computing device subset 430, and may store additional results corresponding to survey results information 420 as illustrated in FIG. 4.

Computing system 200 may access survey results data store 274 and update survey responses 402 of user interest profile records 401 to include information shown in survey results information 420. In some examples, computing system 200 may also update user interest profile records 401 to include information about the survey or survey results. For example, computing system 200 may update interest profile entity listings 403 or other parts of user interest profile records 401 to include interest profile information derived from information stored in survey results data store 274. In some examples, computing system 200 may modify or update one or more interest profile records 401 to include an indication of interest in an event. For example, computing system 200 may modify or update the interest profile records associated with users expressing interest in an event in response to one or more survey questions.

Computing system 200 may analyze user interest profile records 401 and determine interests ranking table 410. Although shown for purposes of illustration as a table, computing system 200 may use any suitable data type or data structure for storing and maintaining interest ranking information. Interests ranking table 410 illustrates, in the left-hand column, a listing of entities, concepts, or interests taken from user interest profile records 401. For each interest in the left-hand column, the right-hand column shows the percentage of computing devices 300 with that interest that detected a high interest survey response. In other words, in the example illustrated in FIG. 4, if one hundred user interest profile records 401 corresponding to users included in the survey had the interest “shoes” as part of interest profile entity listing 403 for that user, interests ranking table 410 shows that fifty-three of those one hundred users responded to the survey with high interest (e.g., response “4” or “5”).

Computing system 200 may rank the entities, topics, interests, or concepts of interests ranking table 410 in descending order of percentage high interest. Computing system 200 may determine one or more of the entities, topics, interests, or concepts in interests ranking table 410 may be effective targeting criteria for interest in the Annual Movie Awards, or may suggest interest or high interest in the Annual Movie Awards. In some examples, the one or more interests most correlated to high interest in the event may be considered or chosen as effective targeting criteria. Computing system 200 may determine, for example, that the profile interest “shoes,” which may be the interest most correlated to high interest in the Annual Movie Awards, may be an effective targeting criterion for notifications, information, commercial messages, and/or advertisements relating to the Annual Movie Awards.

Computing system 200 may determine that other interest profile entity listings 403 may correspond to users that may be interested in receiving information about the Annual Movie Awards. Computing system 200 may identify one or more other interest profile entity listings 403 that include “shoes” in an interest profile entity listing. Users associated with such interest profile entity listings—users who may not have been associated with a computing device in subset 430—may be interested in receiving information about the Annual Movie Awards.

For example, computing system 200 may determine that user interest profile record 401 associated with the user operating computing device 300F includes “shoes” in interest profile entity listing 403 for that user F. Computing system 200 may access or generate a notification and output the notification for transmission over network 110. Computing device 300F may receive the notification, and in response, may generate and display user interface 338. User interface 338 includes a notification about a news item relating to this year's Annual Movie Awards. In some examples, computing device 300F may also or alternatively cause an audio, physical, or other notification to be presented at computing device 300F to indicate to the user of computing device 300F that information of interest may be available.

In another example, computing system 200 may identify one or more other interest profile entity listings 403 that include two or more concepts or entities. For example, computing system 200 may identify profile entity listings that include both “shoes” and “movies.” Computing device 200 may identify the users associated with such profile entity listings. Computing system 200 may determine that such users may be interested in receiving information about the Annual Movie Awards, but that profile entity listings not including both “shoes” and “movies” are associated with users that might not be interested in receiving information about the Annual Movie Awards.

In some examples, computing system 200 may take steps to verify that “shoes” or other topics, concepts, interests, or entities listed in interests ranking table 410 may be effective targeting criteria. For instance, after determining interests ranking table 410, computing system 200 may conduct one or more additional surveys among a different set of computing devices 300, such as computing device subset 432. For ease of illustration in FIG. 4, computing device subset 432 is illustrated as including only computing device 300D and computing device 300E, but computing device subset 432 in most cases will include many more computing devices 300. In some examples, computing system 200 may conduct more than one survey from among computing devices 300 of computing device subset 432; one survey may be a control survey that has no targeting or is based on a random sample of users of computing devices 300, and another survey may be directed only to users of computing devices 300 having the “shoes” in interest profile entity listing 403. Other appropriate surveying techniques may be employed. Computing system 200 may analyze the results of such survey(s) and verify whether “shoes” (or other topics, concepts, interests, or entities) is an effective targeting criteria.

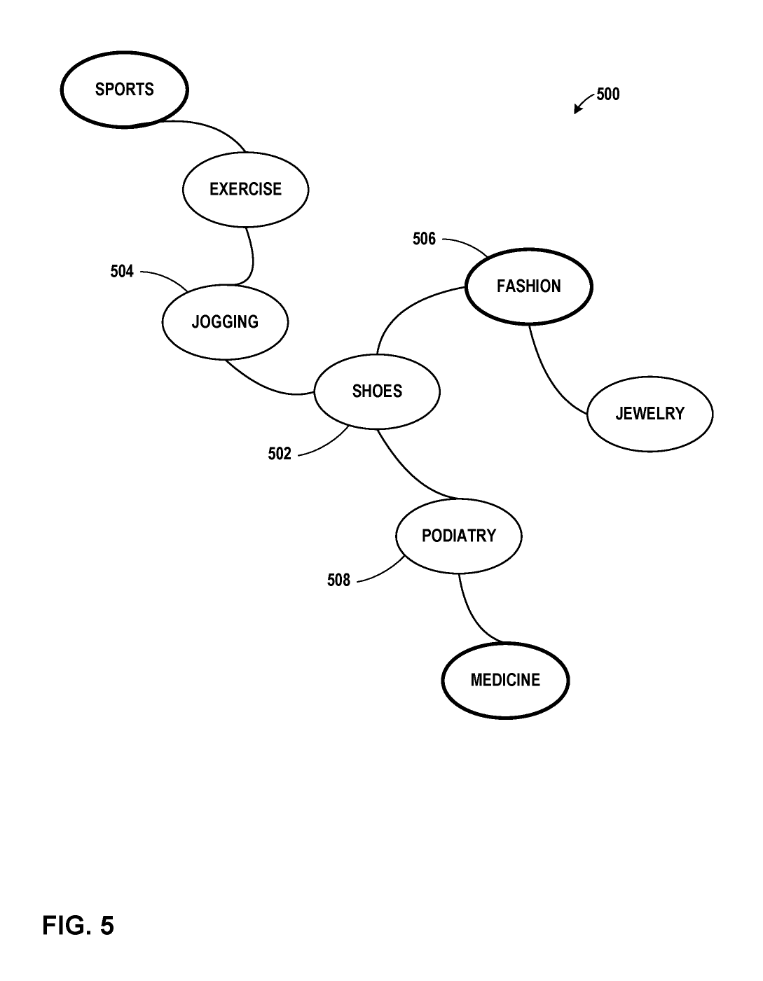

FIG. 5 is a conceptual diagram illustrating a simplified example concept map illustrating relationships between a number of concepts or topics. In concept map 500 of FIG. 5, related concepts are connected by a line, thereby showing relationships (e.g., direct relationships) between one or more concepts. In some examples, one or more of the concepts included in concept map 500 may be the same as, similar to, or correspond to interests that might be found in an interest profile, such as user interest records 401. In the simplified example of FIG. 5, concept map 500 may include, describe, or diagram one or more related interests, entities, concepts, or topics relevant to the example of FIG. 4.

Referring to FIG. 4, computing system 200 may use concept map 500 to identify users that may be interested in the Annual Movie Awards. For example, computing system 200 may conduct a survey from among computing device subset 430 of computing devices 300, and determine interests ranking table 410 as previously described in connection with FIG. 4. Computing system 200 may also determine that user interest profile records that include “shoes” as an interest are associated with users that may be interested in information, notification(s) and/or advertisement(s) relating to the Annual Movie Awards show.

Computing system 200 may further determine that one or more interests that are related to the interest “shoes” may be effective targeting criteria. For instance, computing system 200 may access and/or analyze concept map 500 to determine one or concepts related to “shoes.” In FIG. 5, concepts related to (e.g., adjacent to) “shoes” include “jogging,” “fashion,” and “podiatry.” In one example, computing system 200 may determine, based on information available to computing system 200, information generated by computing system 200, or input detected by computing system 200, that one of the related concepts, such as “fashion,” may be an effective targeting criterion, and may be considered a related interest. Computing system 200 may identify one or more interest profile records that include “fashion” as an interest. Computing system 200 may identify the users associated with such profile entity listings. Computing system 200 may identify one or more (if any) computing devices 300 operated by such users. Computing system 200 may transmit a notification over network 110 to one or more of the identified computing devices 300, which may cause a notification to be presented at one or more computing devices 300.

In addition, computing system 200 may also (or alternatively) determine that another one of the related concepts, such as “jogging,” may be an effective targeting criterion. Computing system 200 may identify one or more interest profile records that include “jogging” as an interest. Computing system 200 may identify the users associated with such profile entity listings, and may identify any computing devices 300 operated by such users. Computing system 200 may transmit a notification over network 110 to one or more of the identified computing devices 300.

In some examples, such as where a wider targeting is desired, computing system 200 may further determine that concepts, interests, entities, or topics that are two (or more) steps away from the interest “shoes” in concept map 500 may be an effective targeting criteria. In the example of FIG. 5, concepts that are two steps away include “exercise,” “jewelry,” and “medicine.” In other examples, computing system 200 may determine that one or more adjacent concepts (e.g., “jogging,” “fashion,” and “podiatry”) and/or one or more concepts further away (e.g., “exercise,” “jewelry,” and “medicine”) might not be effective targeting criterion. Computing system 200 may attempt to verify that such related interests or concepts are effective targeting criteria before such related interests or concepts are relied upon by computing system 200 for targeting.

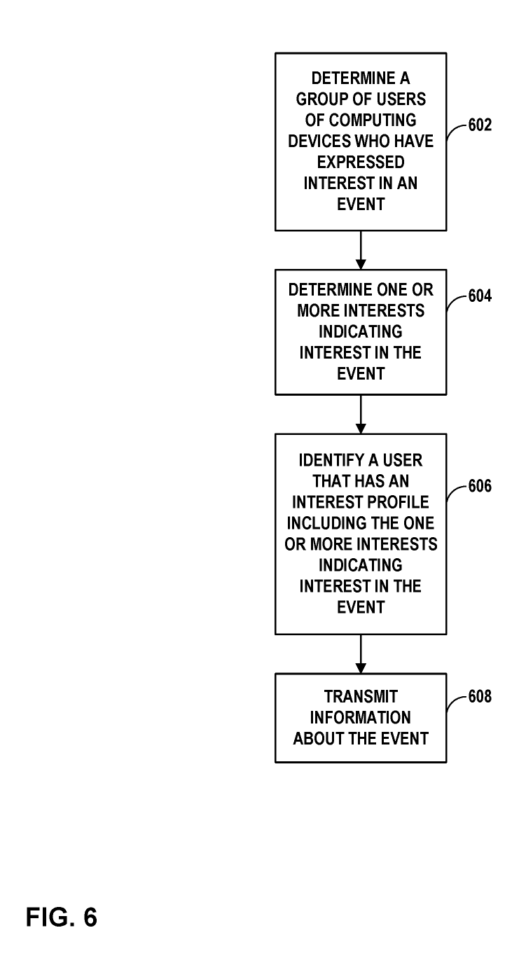

FIG. 6 is a flow diagram illustrating operations performed by an example computing system 200 in accordance with one or more aspects of the present disclosure. FIG. 6 is described below within the context of computing system 200 of FIG. 1, FIG. 2, and/or FIG. 4. In other examples, operations described in FIG. 6 may be performed by one or more other components, modules, systems, or devices. Further, in other examples, operations described in connection with FIG. 6 may be merged, performed in a difference sequence, or omitted.

In the example of FIG. 6, computing system 200 may determine, based on survey information, a group of users of computing devices who have expressed interest in an event, wherein the group of users is included in a plurality of users, and wherein each of the plurality of users has an interest profile (602). For example, computing system 200 conduct a survey of a subset of users of computing devices 300, and may identify one or more users of computing devices 300 that have expressed interest in the Annual Movie Awards.

Computing system 200 may determine, based on the interest profiles for each of the users in the group of users, one or more interests indicating interest in the event (604). For example, computing system 200 may determine that the interest “shoes” is correlated with a high percentage of users indicating interest in the Annual Movie Awards.

Computing system 200 may identify, based on the one or more interests indicating interest in the event, a user not included in the group of users that has an interest profile including the one or more interests indicating interest in the event (606). For example, computing system 200 may identify a user interest profile record that includes “shoes” and is associated with a user not included in the survey.

Computing system 200 may transmit, to a computing device associated with the user, information about the event (608). For example, computing system 200 may send a notification to a computing device operated by a user associated with an interest profile record that includes “shoes.” The notification may provide information about the Annual Movie Awards.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not identified as being performed automatically. Also, certain operations, acts, steps, or events described as being performed automatically might be alternatively not performed automatically, but rather, such operations, acts, steps, or events might be, in some examples, performed in response to input or another event.

Clause 1. A method comprising: determining, by a computing system, based on survey information, a group of users of computing devices who have expressed interest in an event, wherein the group of users is included in a plurality of users, and wherein each of the plurality of users has an interest profile; determining, by the computing system, based on the interest profiles for each of the users in the group of users, one or more interests indicating interest in the event; identifying, by the computing system, based on the one or more interests indicating interest in the event, a user not included in the group of users that has an interest profile including the one or more interests indicating interest in the event; and transmitting, by the computing system, to a computing device associated with the user, information about the event.

Clause 2. The method of clause 1, further comprising: modifying, by the computing device, the interest profiles of the users in the group of users to include an indication of interest in the event.

Clause 3. The method of any of clauses 1-2, further comprising: determining, by the computing device, based on browsing activity, the interest profiles for each of the plurality of users.

Clause 4. The method of any of clauses 1-3, further comprising: determining, by the computing device, based on search activity, the interest profiles for each of the plurality of users.

Clause 5. The method of any of clauses 1-4, wherein the event is an infrequent future event.

Clause 6. The method of any of clauses 1-5, wherein determining the one or more interests indicating interest in the event includes: determining the one or more interests by identifying an interest most correlated to high interest in the event.

Clause 7. The method of any of clauses 1-6, wherein the user is a first user, the method further comprising: determining, based on the one or more interests indicating interest in the event, a related interest; identifying, by the computing system, the related interest in the interest profile of a second user; and transmitting, by the computing system, to a computing device associated with the second user, information about the event.

Clause 8. The method of clause 7, wherein the related interest is adjacent to at least one of the one or more interests indicating interest in the event on a concept graph.

Clause 9. The method of any of clauses 1-8, wherein the group of users is a first group, the method further comprising: determining, by the computing system, a second group of users of computing devices who have expressed interest in the event, wherein the second group of users is included in the plurality of users and is different than the first group; and verifying, by the computing system, whether the one or more interests indicates interest in the event.

Clause 10. A computing system comprising: at least one processor; and at least one storage device that stores instructions that, when executed, cause the at least one processor to: determine, by a computing system, based on survey information, a group of users of computing devices who have expressed interest in an event, wherein the group of users is included in a plurality of users, and wherein each of the plurality of users has an interest profile; determine, by the computing system, based on the interest profiles for each of the users in the group of users, one or more interests indicating interest in the event; identify, by the computing system, based on the one or more interests indicating interest in the event, a user not included in the group of users that has an interest profile including the one or more interests indicating interest in the event; and transmitting, by the computing system, to a computing device associated with the user, information about the event.

Clause 11. The computing system of clause 10, wherein the instructions, when executed, further cause the at least one processor to: modify, by the computing device, the interest profiles of the users in the group of users to include an indication of interest in the event.

Clause 12. The computing system of any of clauses 10-11, wherein the instructions, when executed, further cause the at least one processor to: determine, by the computing device, based on browsing activity, the interest profiles for each of the plurality of users.

Clause 13. The computing system of any of clauses 10-12, wherein the instructions, when executed, further cause the at least one processor to: determine, by the computing device, based on search activity, the interest profiles for each of the plurality of users.

Clause 14. The computing system of any of clauses 10-13, wherein the event is an infrequent future event.

Clause 15. The computing system of any of clauses 10-14, wherein determining the one or more interests indicating interest in the event includes: determining the one or more interests by identifying an interest most correlated to high interest in the event.

Clause 16. The computing system of any of clauses 10-15, wherein the instructions, when executed, further cause the at least one processor to: determine, based on the one or more interests indicating interest in the event, a related interest; identify, by the computing system, the related interest in the interest profile of a second user; and transmit, by the computing system, to a computing device associated with the second user, information about the event.

Clause 17. The computing system of clause 16, wherein the related interest is adjacent to at least one of the one or more interests indicating interest in the event on a concept graph

Clause 18. The computing system of any of clauses 10-17, wherein the group of users is a first group, wherein the instructions, when executed, further cause the at least one processor to: determine, by the computing system, a second group of users of computing devices who have expressed interest in the event, wherein the second group of users is included in the plurality of users and is different than the first group; and verify, by the computing system, whether the one or more interests indicates interest in the event.

Clause 19. A computer-readable storage medium comprising instructions that, when executed, cause at least one processor of a computing system to: determine, by a computing system, based on survey information, a group of users of computing devices who have expressed interest in an event, wherein the group of users is included in a plurality of users, and wherein each of the plurality of users has an interest profile; determine, by the computing system, based on the interest profiles for each of the users in the group of users, one or more interests indicating interest in the event; identify, by the computing system, based on the one or more interests indicating interest in the event, a user not included in the group of users that has an interest profile including the one or more interests indicating interest in the event; and transmitting, by the computing system, to a computing device associated with the user, information about the event.

Clause 20. The computer-readable storage medium of clause 19, wherein the instructions, when executed, further cause the at least one processor to: modify, by the computing device, the interest profiles of the users in the group of users to include an indication of interest in the event.

Clause 21. A system comprising means for performing any of the methods of clauses 1-9.

Clause 22. A computing device comprising means for performing any of the methods of clauses 1-9.

Further, in accordance with one or more aspects of this disclosure, the term “or” may be interrupted as “and/or” where context does not dictate otherwise. Additionally, while phrases such as “one or more” or “at least one” or the like may have been used in some instances but not others, those instances where such language was not used may be interpreted to have such a meaning implied where context does not dictate otherwise.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable

What is claimed is:

1. A method comprising:
determining, by a computing system, based on survey information, a group of users of computing devices who have expressed interest in an event, wherein the group of users is included in a plurality of users, and wherein each of the plurality of users has an interest profile;
determining, by the computing system, based on the interest profiles for each of the users in the group of users, one or more interests indicating interest in the event;
identifying, by the computing system, based on the one or more interests indicating interest in the event, a user not included in the group of users that has an interest profile including the one or more interests indicating interest in the event; and
transmitting, by the computing system, to a computing device associated with the user, information about the event.

2. The method of claim 1, further comprising:
modifying, by the computing device, the interest profiles of the users in the group of users to include an indication of interest in the event.

3. The method of claim 1, further comprising:
determining, by the computing device, based on browsing activity, the interest profiles for each of the plurality of users.

4. The method of claim 1, further comprising:
determining, by the computing device, based on search activity, the interest profiles for each of the plurality of users.

5. The method of claim 1, wherein the event is an infrequent future event.

6. The method of claim 1, wherein determining the one or more interests indicating interest in the event includes:
determining the one or more interests by identifying an interest most correlated to high interest in the event.

7. The method of claim 1, wherein the user is a first user, the method further comprising:
determining, based on the one or more interests indicating interest in the event, a related interest;
identifying, by the computing system, the related interest in the interest profile of a second user; and
transmitting, by the computing system, to a computing device associated with the second user, information about the event.

8. The method of claim 7, wherein the related interest is adjacent to at least one of the one or more interests indicating interest in the event on a concept graph.

9. The method of claim 1, wherein the group of users is a first group, the method further comprising:
determining, by the computing system, a second group of users of computing devices who have expressed interest in the event, wherein the second group of users is included in the plurality of users and is different than the first group; and
verifying, by the computing system, whether the one or more interests indicates interest in the event.

10. A computing system comprising:
at least one processor; and
at least one storage device that stores instructions that, when executed, cause the at least one processor to:
determine, based on survey information, a group of users of computing devices who have expressed interest in an event, wherein the group of users is included in a plurality of users, and wherein each of the plurality of users has an interest profile;
determine, based on the interest profiles for each of the users in the group of users, one or more interests indicating interest in the event;
identify, based on the one or more interests indicating interest in the event, a user not included in the group of users that has an interest profile including the one or more interests indicating interest in the event; and
transmit, to a computing device associated with the user, information about the event.

11. The computing system of claim 10, wherein the instructions, when executed, further cause the at least one processor to:
modify the interest profiles of the users in the group of users to include an indication of interest in the event.

12. The computing system of claim 10, wherein the instructions, when executed, further cause the at least one processor to:
determine, based on browsing activity, the interest profiles for each of the plurality of users.

13. The computing system of claim 10, wherein the instructions, when executed, further cause the at least one processor to:
determine, based on search activity, the interest profiles for each of the plurality of users.

14. The computing system of claim 10, wherein the event is an infrequent future event.

15. The computing system of claim 10, wherein the instructions, when executed, further cause the at least one processor to determine the one or more interests indicating interest in the event by at least:
determining the one or more interests by identifying an interest most correlated to high interest in the event.

16. The computing system of claim 10, wherein the instructions, when executed, further cause the at least one processor to:
determine, based on the one or more interests indicating interest in the event, a related interest;
identify, the related interest in the interest profile of a second user; and
transmit, to a computing device associated with the second user, information about the event.

17. The computing system of claim 16, wherein the related interest is adjacent to at least one of the one or more interests indicating interest in the event on a concept graph.

18. The computing system of claim 10, wherein the group of users is a first group, wherein the instructions, when executed, further cause the at least one processor to:
determine, a second group of users of computing devices who have expressed interest in the event, wherein the second group of users is included in the plurality of users and is different than the first group; and
verify whether the one or more interests indicates interest in the event.

19. A computer-readable storage medium comprising instructions that, when executed, cause at least one processor of a computing system to:
determine, based on survey information, a group of users of computing devices who have expressed interest in an event, wherein the group of users is included in a plurality of users, and wherein each of the plurality of users has an interest profile;
determine, based on the interest profiles for each of the users in the group of users, one or more interests indicating interest in the event;
identify, based on the one or more interests indicating interest in the event, a user not included in the group of users that has an interest profile including the one or more interests indicating interest in the event; and
transmit, to a computing device associated with the user, information about the event.

20. The computer-readable storage medium of claim 19, wherein the instructions, when executed, further cause the at least one processor to:
modify the interest profiles of the users in the group of users to include an indication of interest in the event.
